(19) United States
(12) Patent Application Publication
(10) Pub. No.: US 2026/0201905 A1
(43) Pub. Date: Jul. 16, 2026

(54) FAN DEVICE

(71) Applicant: COOLER MASTER TECHNOLOGY INC., Taipei City (TW)

(72) Inventor: Jheng-Sian CAI, Taipei City (TW)

(73) Assignee: COOLER MASTER TECHNOLOGY INC., Taipei City (TW)

(21) Appl. No.: 19/415,321

(22) Filed: Dec. 10, 2025

Related U.S. Application Data
(60) Provisional application No. 63/743,967, filed on Jan. 10, 2025.

(51) Int. Cl. F04D 29/64; F04D 25/16; F21V 29/60

(52) U.S. Cl. CPC F04D 29/646; F04D 25/166; F21V 29/60

(57) ABSTRACT

A fan includes a fan and a light emitting assembly. The fan has a first engaging portion and an electrically connecting portion. The electrically connecting portion is located at the first engaging portion. The light emitting assembly includes a back plate, a conductive structure and a light emitting component. The back plate is disposed on the fan, and has a through slot and a second engaging portion. The second engaging portion is located at the through slot. The second engaging portion is engaged with the first engaging portion. The conductive structure is disposed through the through slot. The conductive structure is located at the second engaging portion. The conductive structure is connected to the electrically connecting portion via the first engaging portion and the second engaging portion. The light emitting component is disposed on the back plate. The conductive structure is connected to the light emitting component.

### CROSS-REFERENCE TO RELATED APPLICATIONS

This non-provisional application claims priority under 35 U.S.C. § 119(a) on provisional Patent Application No(s). 63/743,967 filed in US, on January 10th, 2025 , the entire contents of which are hereby incorporated by reference.

### TECHNICAL FIELD

The present disclosure relates to a fan device, more particularly to a fan device having a light emitting assembly.

### BACKGROUND

With the rapid development of technology, the computation performance of processors of an electronic product has also improved significantly, while a large amount of heat has been generated. In order to ensure that the processors will not be damaged due to high temperature, a fan is generally provided in the electronic product to cool the processors, so that the processors can operate within an adequate temperature range.

Fan manufacturers not only focus on the existing cooling function of the fan but also increasingly emphasize the aesthetic appearance of the fan during operation. Generally, multiple light emitting components are additionally installed in the fan, such that the light emitting components emit the light from the side of the fan, thereby producing an appealing visual effect when the fan is operating. However, during the assembly of the light emitting fan, multiple additional fasteners are usually required to fix the light emitting components and the fan frame. Accordingly, the assembly process of the light emitting fan may be overly complicated and time consuming. Therefore, how to simplify the overly complicated assembly process of the light emitting fan is one of the problems that needs to be addressed.

### SUMMARY

The present disclosure provides a fan device so as to simplify the assembly process of the fan device configured for light emitting.

One embodiment of the present disclosure provides a fan including at least one fan and a light emitting assembly. The at least one fan has at least one first engaging portion and at least one electrically connecting portion. The at least one electrically connecting portion is located at the at least one first engaging portion. The light emitting assembly includes a back plate, at least one conductive structure and a light emitting component. The back plate is disposed on a side of the at least one fan, and has at least one through slot and at least one second engaging portion. The at least one second engaging portion is located at the at least one through slot. The at least one second engaging portion is engaged with the at least one first engaging portion. The at least one conductive structure is disposed through the at least one through slot. The at least one conductive structure is partially located at the at least one second engaging portion. A side of the at least one conductive structure is electrically connected to the at least one electrically connecting portion via an engagement between the at least one first engaging portion and the at least one second engaging portion. The light emitting component is disposed on a side of the back plate away from the at least one fan. Another side of the at least one conductive structure is electrically connected to the light emitting component.

According to the fan device as described in the above embodiments, the conductive structures are partially located at the second engaging portions, respectively. Therefore, when the back plate is fixed to the fans via the engagement between the second engaging portions and the first engaging portions, the conductive structures can be electrically connected to the electrically connecting portions, respectively. That is, the assembly of the light emitting assembly and the fans and the electrical connection between the conductive structures and the electrically connecting portions can be completed simultaneously in a single assembly step. Accordingly, the convenience of mounting the light emitting assembly onto the fans can be improved, thereby simplifying the assembly process of the fan device configured for light emitting.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a perspective view of a fan device in accordance with an embodiment of the present disclosure;

FIG. 2 is an exploded view of the fan device in FIG. 1;

FIG. 3 is another exploded view of the fan device in FIG. 1;

FIG. 4 is a cross-sectional view of the fan device in FIG. 1;

FIG. 5 is another cross-sectional view of the fan device in FIG. 1; and

FIG. 6 is a partially enlarged view of the fan device in FIG. 5

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the present disclosure, such as technical and scientific terms, have its own meanings and can be comprehended by those skilled in the art, unless the terms are additionally defined in the present disclosure. That is, the terms used in the following paragraphs should be read on the meaning commonly used in the related fields and will not be overly explained, unless the terms have a specific meaning in the present disclosure.

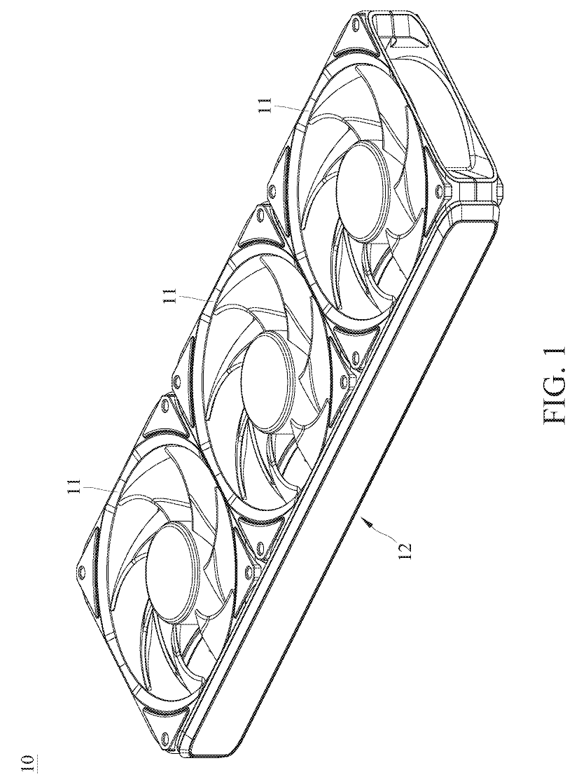

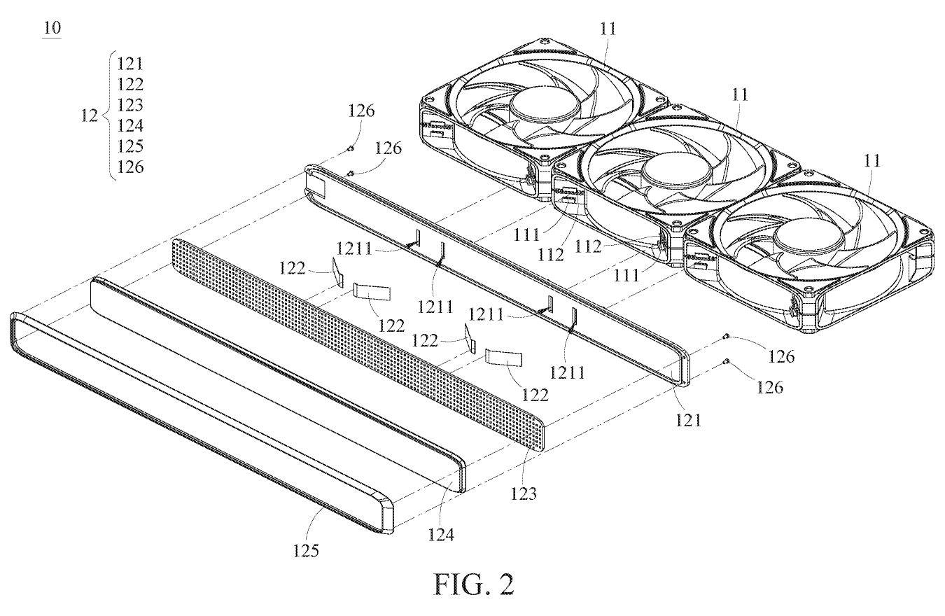

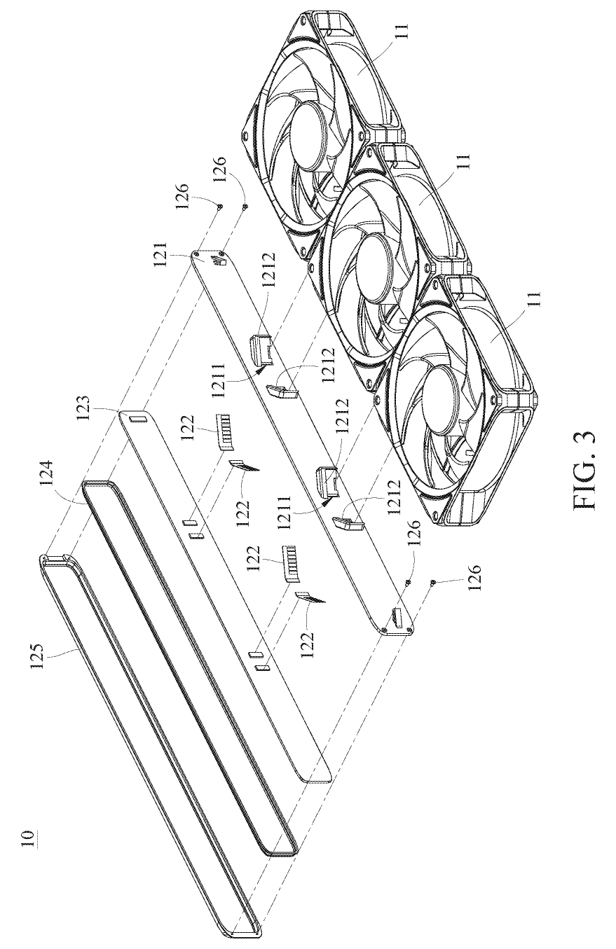

Please refer to FIG. 1 to FIG. 3, where FIG. 1 is a perspective view of a fan device 10 in accordance with an embodiment of the present disclosure, FIG. 2 is an exploded view of the fan device 10 in FIG. 1, and FIG. 3 is another exploded view of the fan device 10 in FIG. 1.

In this embodiment, the fan device 10 includes a plurality of fans 11 and a light emitting assembly 12. The fan device 10 is electrically connected to, for example, an external power source, such that the external power source can power the fan 11 to operate and allow the light emitting assembly 12 to emit light. The fans 11 are arranged, for example, side by side along a straight line. Each of the fans 11 has a plurality of first engaging portions 111 and and a plurality of electrically connecting portions 112. The electrically connecting portions 112 are located at the first engaging portions 111, respectively. The electrically connecting portions 112 are, for example, pogo pins, but the present disclosure is not limited thereto.

The light emitting assembly 12 includes a back plate 121, a plurality of conductive structures 122, a light emitting component 123, a display panel 124, a frame 125 and a plurality of fasteners 126. The back plate 121 is disposed on a side of the fans 11, and has a plurality of through slots 1211 and a plurality of second engaging portions 1212.

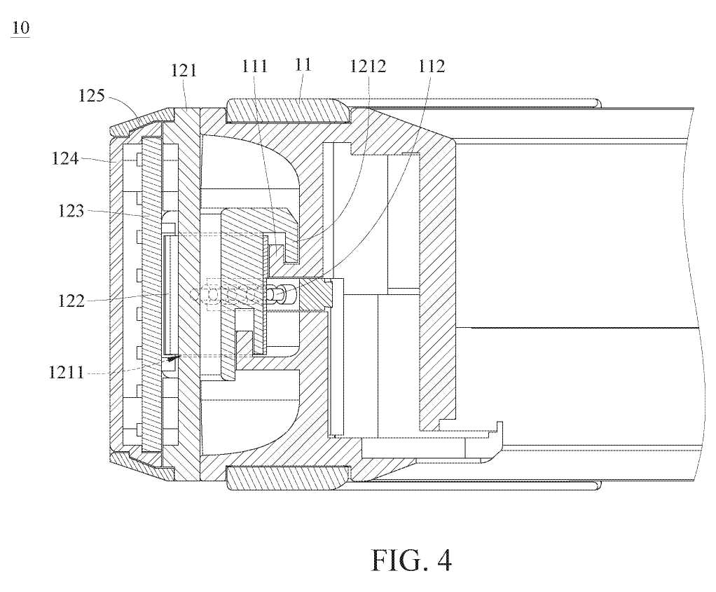

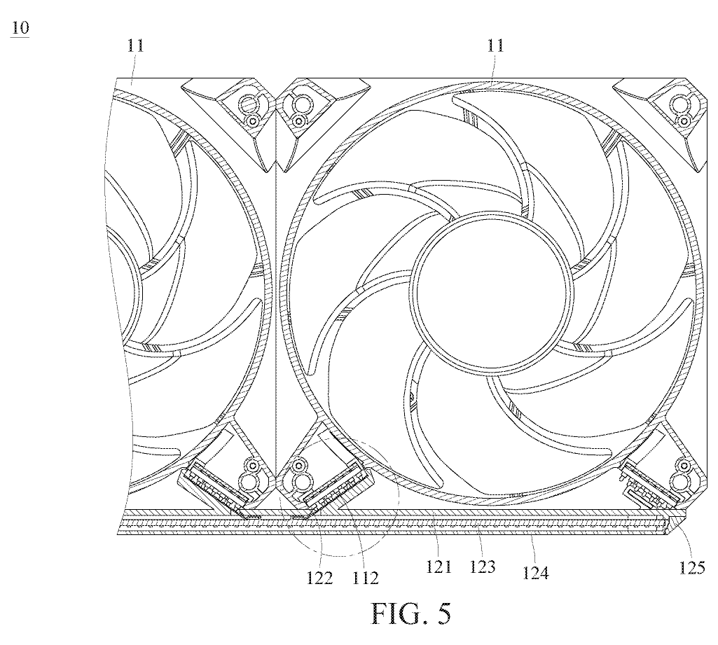

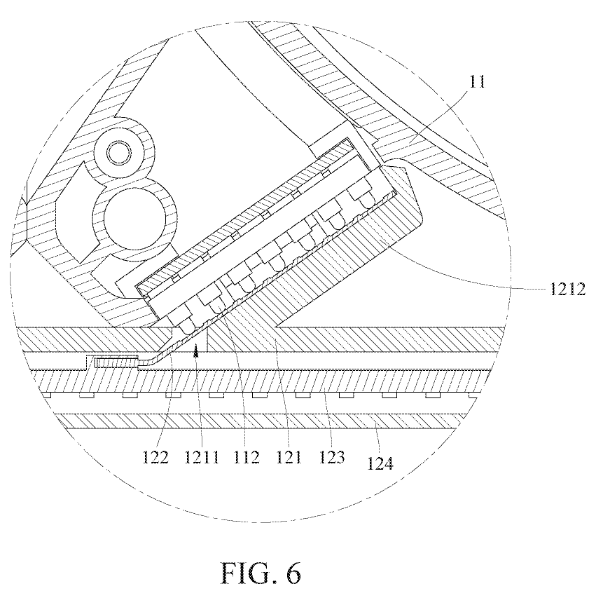

Please refer to FIG. 1 to FIG. 6, where FIG. 4 is a cross-sectional view of the fan device 10 in FIG. 1, FIG. 5 is another cross-sectional view of the fan device 10 in FIG. 1, and FIG. 6 is a partially enlarged view of the fan device 10 in FIG. 5.

The second engaging portions 1212 are located at the through slots 1211, respectively. The second engaging portions 1212 are engaged with the first engaging portions 111, respectively, such that the back plate 121 can be fixed to the fans 11. The first engaging portions 111 and the second engaging portions 1212 are, for example, hooks matching with each other.

In addition, for example, extending directions of the first engaging portions 111 and the second engaging portions 1212 and an extending direction of the back plate 121 are non-parallel, and the extending direction of the first engaging portions 111 and the extending direction of the second engaging portions 1212 are non-parallel. For example, the first engaging portions 111 and the second engaging portions 1212 are arranged in an inclined configuration, and the inclined directions of any two adjacent first engaging portions 111 and second engaging portions 1212 are different from each other.

The conductive structures 122 are disposed through the through slots 1211, respectively. The conductive structures 122 are partially located at the second engaging portions 1212, respectively, such that a side of the conductive structures 122 are electrically connected to at least a part of the electrically connecting portions 112 via an engagement between the first engaging portions 111 and the second engaging portions 1212. The conductive structures 122 are in the form of, for example, conductive sheets such as flexible circuit boards.

The light emitting component 123 is disposed on a side of the back plate 121 away from the fans 11. Another side of the conductive structures 122 is electrically connected to the light emitting component 123, such that the external power can be transferred from the fans 11 to the light emitting component 123 via the electrically connecting portions 112 and the conductive structures 122. The light emitting component 123 is, for example, a circuit boards having light emitting diodes (LED).

The display panel 124 is disposed on a side of the light emitting component 123 away from the back plate 121. The display panel 124 is made of a plastic material such as acrylic, and is, for example, translucent and glossy black. In addition, the light emitting component 123 emits light toward the display panel 124, thereby enabling the display panel 124 to display an image.

The frame 125 is disposed on the back plate 121. In detail, the frame 125 is fastened to the back plate 121 via, for example, the fasteners 126. The fasteners 126 are, for example, screws. The frame 125 surrounds the light emitting component 123 and the display panel 124 to prevent the light emitting component 123 and the display panel 124 from falling.

In this embodiment, the conductive structures 122 are partially located at the second engaging portions 1212, respectively. Therefore, when the back plate 121 is fixed to the fans 11 via the engagement between the second engaging portions 1212 and the first engaging portions 111, the conductive structures 122 can be electrically connected to the electrically connecting portions 112, respectively. That is, the assembly of the light emitting assembly 12 and the fans 11 and the electrical connection between the conductive structures 122 and the electrically connecting portions 112 can be completed simultaneously in a single assembly step. Accordingly, the convenience of mounting the light emitting assembly 12 onto the fans 11 can be improved, thereby simplifying the assembly process of the fan device 10 configured for light emitting.

In this embodiment, there are multiple fans 11, multiple first engaging portions 111, multiple electrically connecting portions 112, multiple through slots 1211, multiple second engaging portions 1212 and multiple conductive structures 122, but the present disclosure is not limited thereto. In other embodiments, there may be one fan, one first engaging portion, one electrically connecting portion, one through slot, one second engaging portion and one conductive structure.

In this embodiment, the fans 11 are arranged side by side along a straight line, but the present disclosure is not limited thereto. In other embodiments, the fans may be arranged, for example, in an array or in other forms.

In this embodiment, the first engaging portions 111 and the second engaging portions 1212 are hooks matching with each other, but the present disclosure is not limited thereto. In other embodiments, the first engaging portions and the second engaging portions may be engaging protrusions and engaging recesses matching with each other.

In this embodiment, the light emitting assembly 12 includes the plurality of fasteners 126 such as screws, such that the frame 125 can be fastened to the back plate 121 via the fasteners 126, but the present disclosure is not limited thereto. In other embodiments, the light emitting assembly may include other types of fasteners. Alternatively, the light emitting assembly may not include fasteners, and the frame is fastened to the back plate by other fixing manners.

According to the fan device as described in the above embodiments, the conductive structures are partially located at the second engaging portions, respectively. Therefore, when the back plate is fixed to the fans via the engagement between the second engaging portions and the first engaging portions, the conductive structures can be electrically connected to the electrically connecting portions, respectively. That is, the assembly of the light emitting assembly and the fans and the electrical connection between the conductive structures and the electrically connecting portions can be completed simultaneously in a single assembly step. Accordingly, the convenience of mounting the light emitting assembly onto the fans can be improved, thereby simplifying the assembly process of the fan device configured for light emitting.

It will be apparent to those skilled in the art that various modifications and variations can be made to the present disclosure. It is intended that the specification and examples be considered as exemplary embodiments only, with a scope of the present disclosure being indicated by the following claims.

What is claimed is:

1. A fan device, comprising:
at least one fan, having at least one first engaging portion and at least one electrically connecting portion, wherein the at least one electrically connecting portion is located at the at least one first engaging portion; and
a light emitting assembly, comprising:
a back plate, disposed on a side of the at least one fan and having at least one through slot and at least one second engaging portion, wherein the at least one second engaging portion is located at the at least one through slot, and the at least one second engaging portion is engaged with the at least one first engaging portion;
at least one conductive structure, disposed through the at least one through slot, wherein the at least one conductive structure is partially located at the at least one second engaging portion, and a side of the at least one conductive structure is electrically connected to the at least one electrically connecting portion via an engagement between the at least one first engaging portion and the at least one second engaging portion; and
a light emitting component, disposed on a side of the back plate away from the at least one fan, wherein another side of the at least one conductive structure is electrically connected to the light emitting component.

2. The fan device according to claim 1, wherein the light emitting assembly further comprises a display panel, and the display panel is disposed on a side of the light emitting component away from the back plate.

3. The fan device according to claim 2, wherein the light emitting assembly further comprises a frame, the frame is disposed on the back plate, and surrounds the light emitting component and the display panel.

4. The fan device according to claim 3, wherein the light emitting assembly further comprises a plurality of fasteners, and the frame is fastened to the back plate via the plurality of fasteners.

5. The fan device according to claim 2, wherein the display panel is made of acrylic.

6. The fan device according to claim 1, wherein extending directions of the at least one first engaging portion and the at least one second engaging portion and an extending direction of the back plate are non-parallel.

7. The fan device according to claim 1, wherein the at least one conductive structure is a flexible circuit board.

8. The fan device according to claim 1, wherein the at least one electrically connecting portion is a pogo pin.

9. The fan device according to claim 1, wherein the at least one fan comprises a plurality of fans, the at least one first engaging portion comprises a plurality of first engaging portions, the at least one electrically connecting portion comprises a plurality of electrically connecting portions, the at least one through slot comprises a plurality of through slots, the at least one second engaging portion comprises a plurality of second engaging portions, the at least one conductive structure comprises a plurality of conductive structures, and the plurality of fans are arranged side by side along a straight line.

10. The fan device according to claim 9, wherein an extending direction of the plurality of first engaging portions and an extending direction of the plurality of second engaging portions are non-parallel.
